(19) United States
(12) Patent Application Publication
(10) Pub. No.: US 2014/0032392 A1
(43) Pub. Date: Jan. 30, 2014

(54) FINANCING SYSTEMS INTEGRATION

(71) Applicant: Naeem M. Ansari, Santa Clara, CA (US)

(72) Inventor: Naeem M. Ansari, Santa Clara, CA (US)

(73) Assignee: Apple Inc., Cupertino, CA (US)

(21) Appl. No.: 13/562,139

(22) Filed: Jul. 30, 2012

(51) Int. Cl. G06Q 40/02

(52) U.S. Cl. 705/38

(57) ABSTRACT

The present technology pertains to receiving loan applications, collecting loan applications and sending loan applications to financial partners, receiving loan approvals, identifying customers based on loan application identification numbers, fulfilling property transfer orders using approved loans, and receiving payment from financial partners upon fulfillment. An integrated financing and property transfer management platform for receiving loan requests, routing loan requests, receiving login requests using loan identifiers, processing the transfer of property rights, fulfilling property rights transfers, and receiving payment from financial institutions. Programming interfaces for integrating financial institutions with a property transfer management platform. User interfaces for requesting loans and fulfilling property rights transfers using loans.

### BACKGROUND

1. Technical Field

The present technology relates generally to financing integration with an e-commerce marketplace, and more specifically, the present technology relates to a Financing Systems Integration system that allows customers to shop and checkout using a Loan ID.

2. Introduction

Many systems exist for processing credit card sales, both in brick-and-mortar point-of-sale scenarios and in online markets. Credit card transactions are familiar to customers and retailers, but suffer from many drawbacks. For example, onboarding and implementing online credit card systems can come with a very high cost. Also, each credit card provider can have different standards and requirements that can prevent standardized network communication protocols. Finally, credit card companies charge a high percentage of each sale made with a credit card.

To avoid the fees and setup costs associated with credit cards, a customer wanting to finance a purchase could apply for a loan or a personal line of credit from a bank or other financing company. However, this process is tedious—requiring many manual steps such as calling or driving to a bank, speaking to a banker, providing personal financial information, obtaining copies of pay slips, signing loan documents, waiting for approval, and maintaining a loan account. There is a need to simplify this process and integrate it into the sales experience—both in online markets and in physical point-of-sale retail scenarios.

Additionally, educational loans are oftentimes used to purchase items needed for an educational program. Many students use laptop computers for note taking, conducting research, writing term papers, taking tests, etc. Indeed, sometimes computer equipment is required for a class—such as computer programming, graphic design, animation, etc. Some educational loan providers provide loans for these expenses, but the process is disconnected from the sales experience, involves an unfamiliar interface, or involves one or more of the manual steps described above. Consequently, there is a need to simplify the educational loan process and integrate it into the sales experience.

Furthermore, business-to-business sales sometime involve equipment lease programs or payment using financing. For example, many business lease computer hardware and license enterprise level software systems. However, the process for obtaining these business leases and licenses involve a business customer calling a sales representative, ordering items, arranging financing through a third party, and working with the supplier's interface—which can be esoteric, proprietary, and unfamiliar. There is a need to simplify the business-to-business sales, lease, and licensing processes and integrate it into the sales experience.

Additionally, known systems for providing financing for making purchases involve generally no visibility into the process. For example, oftentimes customers are left to wonder if a loan will be approved, if an order has been shipped, or if a payment has been processed. Likewise, the financing partners do not gain visibility into the seller's system to determine when to provide payment to the seller per the financing contract with the customer. There is a need to standardize financing workflows, integrate financing partners' systems into a central system, and provide process visibility.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Some embodiments of the present technology integrate point-of-sale (POS), online sales checkout processes, and enterprise business sales interfaces with systems for authorizing, managing, and settling loan instruments and credit products through third party financial partners. Some embodiments of the present technology use a Financing System Integration (FSI) engine to integrate POS and online store checkout platforms with financing partners. Some embodiments of the present technology utilize standard protocols and APIs to seamlessly integrate the loan process with an online store or POS terminal. In some embodiments of the present technology, a customer can apply for a loan, automatically be approved, receive a Loan Identification Number (Loan ID), and use the Loan Identification Number (Loan ID) to complete a transaction.

In some embodiments of the present technology, the FSI engine is operatively coupled with online and POS retail terminals selling, leasing, or licensing physical or digital items. In some embodiments of the present technology, the FSI engine uses one or more software services to manage orders, shipping, user accounts, partner records, payments, inventory, etc. In some embodiments of the present technology, the FSI engine communicates with financing partners using standardized protocols, thereby providing a consistent experience.

Some embodiments of the present technology involve a system for integrating a financing institution and a sales partner using an integrated financing integration (FSI) engine configured to transmit a request for a loan along with loan application information to the financing institution, receive a loan approval communication from the financing institution, complete a financial transaction with the sales partner wherein the transaction exchanges a right in an item offered for sale by the sales partner secured by the approved loan, and notify the financing institution of the transaction amount and item purchased with the approved loan.

Some embodiments of the present technology involve a method comprising receiving from a financial institution a loan approval communication including a loan number, a loan amount, and a loan application identifier and receiving from a client device a purchase request for an item in an online store and the loan number as payment for the item. Some embodiments of the present technology include receiving a request for a loan from a customer along with loan application information and transmitting the request for a loan along with loan application information to the financial institution. Some embodiments of the present technology include receiving a loan application communication along with a loan number and order details and creating a quoted order based on the order details. Some embodiments of the present technology include, upon receiving a loan approval communication, changing the quoted order to an approved order. Some embodiments of the present technology include fulfilling an approved order by delivering the item to the customer, notifying the financial institution that the order is fulfilled, and receiving payment for the item from the financial institution. Some embodiments of the present technology include sending batch updates to the financial institution, the batch updates relating to the quoted order, the approved order, the customer, and the loan application.

Some embodiments of the present technology involve a system integrating a financing institution and a business-to-business (B2B) sales partner using an integration platform comprising an integrated financing integration (FSI) engine and an intermediary application tool. In some embodiments of the present technology the intermediary application tool is configured to present the B2B sales partner with financing products, obtain the B2B sales partner's financing product selections, generate a financing application form for the B2B sales partner, transmit a request for financing along with the application form to the financing institution, receive a loan approval communication from the financing institution along with loan terms, transmit the approval communication and loan terms to the B2B sales partner, and receive the B2B sales partner's approval of the loan terms. In some embodiments of the present technology the FSI engine is configured to complete a financial transaction with the sales partner wherein the transaction exchanges a right in an item offered for sale by the sales partner secured by the approved loan, and notify the financing institution of the transaction amount and item purchased with the approved loan.

In some embodiments of the present technology, a computer readable medium is configured for performing the methods described above and herein.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system having a Financing System Integration (FSI) engine coupled with sales and financing partners in a network environment according to some embodiments of the present technology;

FIG. 2 illustrates an exemplary system integrating previously unconnected systems and partners through a central Financial System Integration (FSI) engine according to some embodiments of the present technology;

FIG. 3 illustrates an exemplary interface for customers to checkout of an online retail store using a Loan ID number relating to a loan from a financing partner according to some embodiments of the present technology;

FIG. 4 illustrates an exemplary interface for customers to checkout of an online retail store using a Loan ID number relating to an educational loan according to some embodiments of the present technology;

FIG. 5 illustrates an exemplary method of checking out a customer who applies for a loan upstream and uses a Loan ID to pay at checkout according to some embodiments of the present technology;

FIG. 6 illustrates an exemplary method of checking out a customer who first shops and later applies for a loan downstream at checkout according to some embodiments of the present technology;

FIG. 7 illustrates an exemplary online interface for a customer to apply to lease items from an online retailer via a lease agreement from a financing partner according to some embodiments of the present technology;

FIG. 8 illustrates an exemplary method of taking orders from enterprise business customer, securing financing, and order fulfillment in an enterprise business financing scenario according to some embodiments of the present technology;

FIG. 9 illustrates an exemplary point-of-sale terminal interface on a mobile device according to some embodiments of the present technology;

FIG. 10 illustrates an exemplary dataflow diagram illustrating a process of conducting a financing sale with a point-of-sale terminal according to some embodiments of the present technology;

FIG. 11 illustrates an exemplary method of return merchandise authorization (RMA), new order fulfillment, and settlement with a financing partner according to some embodiments of the present technology;

FIG. 12 illustrates a high-level data flow diagram showing information exchange between the FSI engine and financing partners using standardized protocols and APIs according to some embodiments of the present technology;

FIG. 13 illustrates a system diagram showing high-level interaction between the FSI engine, customers, and financing partners using standardized protocols according to some embodiments of the present technology;

FIG. 14 illustrates an exemplary workflow for securing financing with a foreign financing institution and complying with Europe, Middle East, India, and Africa (EMEIA) regulations according to some embodiments of the present technology; and

FIG. 15 illustrates an exemplary computer system for implemented the present technology according to some embodiments of the present technology.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well known methods, procedures, components, circuits, and networks have not been described in detail so as not to unnecessarily obscure aspects of the embodiments.

The present technology integrates point-of-sale (POS) terminals, online sales checkout processes, and enterprise business sales interfaces with systems for approving, managing, and settling loan instruments and credit products through third party financial partners. The present technology uses a Financing System Integration (FSI) engine to integrate POS and online store checkout platforms with financing partners. The customer can apply for a loan, automatically be approved, and receive a Loan Identification Number (Loan ID). In some embodiments of the present technology, the customer can checkout and complete a transaction using a Loan Identification Number (Loan ID) as a form of payment. Using standard protocols and APIs, the loan process can be seamlessly integrated into existing financing systems.

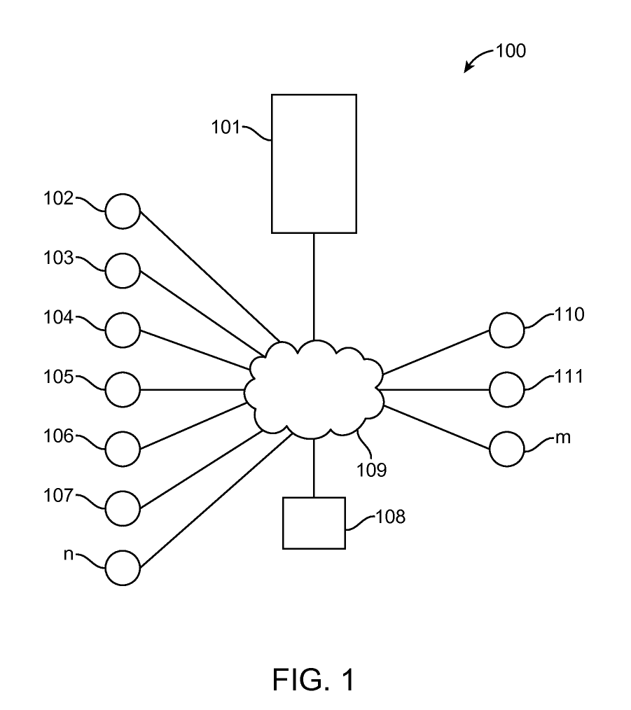

FIG. 1 illustrates an exemplary system 100 having a Financing System Integration (FSI) engine 101 coupled with sales and financing partners in a network environment according to some embodiments of the present technology. As used herein, the term “financing partner” shall refer to an actual financing partner (e.g. a bank) or to software services, operated by or on behalf of the actual financing partner, for performing aspects of the technology disclosed herein. The FSI engine 101 comprises a server-based processing engine coupled with a network 109. In some embodiments, the FSI engine 101 includes one or more processing modes or sub-modes for performing some or all of the processing functions, as will be described in greater detail below.

In some embodiments of the present technology, the FSI engine 101 is operated by a sales partner. For example, in some embodiments of the present technology, the operator of an online store also operates the FSI engine.

As shown in FIG. 1, the FSI engine 101 is coupled with a plurality of sales partners 102, 103, 104, 105, 106, 107, . . . n. The sales partners take purchase orders and facilitate the delivery of goods and services to individual customers and business customers.

In some embodiments of the present technology, the sales partner 102 can comprise physical point-of-sale (POS) retailers. For example, in some embodiments of the present technology, the sales partner 102 can include one or more brick-and-mortar retail outlets such as an Apple Store®. In some embodiments of the present technology, the sales partner 103 can comprise online retailers. For example, the sales partner 103 can comprise an online store, such as the Apple Online Store. In some embodiments, the sales partner 104 can comprise an application distribution system, such as the App Store^{SM}, available from Apple Inc. of Cupertino, Calif. or a media distribution system, such as the iTunes®, available from Apple Inc. of Cupertino, Calif.

In some embodiments of the present technology, the sales partner 105 can comprise a point-of-sale business partner and OEM reseller. For example, the sales partner 105 can comprise a mobile device reseller who offers services such as cellular or network connectivity for the mobile device.

In some embodiments of the present technology, the sales partner 107 can comprise a business-to-business buyer. For example, the sales partner 107 can comprise a business purchasing enterprise level software solutions or leasing computer hardware for an entire enterprise.

In some embodiments of the present technology, the sales partners can also comprise online aggregators, distributors, and re-sellers. In some embodiments, the sales partner 106 can comprise an online marketplace that aggregates one or more online retailers—each of which facilitate business to consumer sales and business to business sales. Additionally, in some embodiments, the sales partner 106 can comprise an online bidding website that serves as a platform for a plurality of people and businesses to action, bid, buy, and sell a wide variety of goods and services.

Although specific examples of sales partners are provided herein, it will be readily apparent to those with ordinary skill in the art having the benefit of this disclosure that a wide variety of physical and online sales partners can benefit from advantages of the present technology.

The FSI engine 101 is also coupled with one or more financing partners 110, 111, . . . m. In some embodiments of the present technology, the financing partners provides one or more financial service such as providing loans, leasing services, licensing services, third party lines of credit, etc. For example, in some embodiments of the present technology, the financing partner 110 comprises a bank.

The FSI engine 101 can be configured to provide customers with financing options and can be configured to manage the product order/fulfillment and financing lifecycles. In some embodiments of the present technology, one or more software service 108 is coupled with the FSI engine 101 and configured for providing backend order management, customer relationship management (CRM), and payment collection services, as explained in greater detail below.

As explained above, previous systems for purchasing goods through financing involves a series of manual steps. Also the application/authorization/settlement process can be different for each financing partner. Accordingly, the present technology eliminates manual steps, provides a unified and consistent interface, automates the loan application and approval processes, ensures order fulfillment, and provides financing lifecycle visibility. In some embodiments of the present technology, customers are presented with the option to make payment using financing offered from one of the financing partners at the time of a sale. The FSI engine gathers order information from the sales partners and assigns a Loan Identification (ID) to the customer. Using the Loan ID as the basis for identifying the transaction, the FSI engine further collects financing application information from the customer, sends the collected information to the financing partners, receives approval information, schedules order fulfillment and delivery, invoices the financial partner, and receives payment. The sales partners, financing partners, and software services all communicate via the FSI engine using the Loan ID. Consequently, the system is completely standardized and highly scalable.

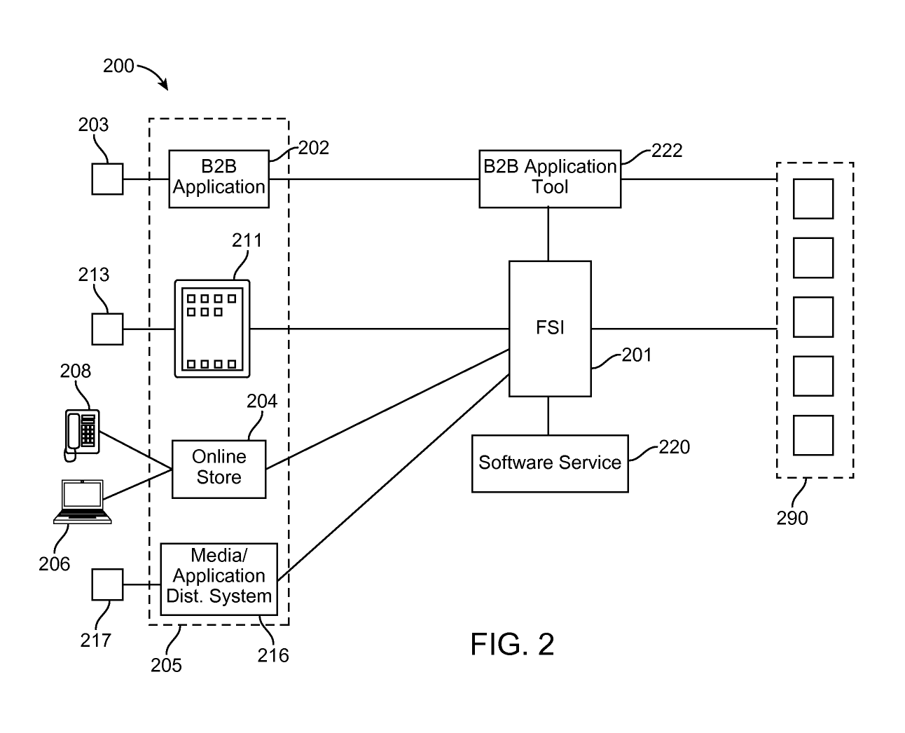

FIG. 2 illustrates an exemplary system 200 integrating previously unconnected systems and partners through a central Financial System Integration (FSI) engine 201 according to some embodiments of the present technology. The FSI engine 201 comprises a network-based processing engine coupled with one or more sales outlets 205 and one or more financing partners 290. The sales outlets 205 comprise various online and physical stores including online stores 204, physical store point-of-sale (POS) terminals 211, media and application distribution systems 216, etc. The FSI engine is also operatively coupled with one or more software service 220 configured for providing backend inventory, order management, CRM, and payment collection services.

In some embodiments of the present technology, the sales outlets 205 include an online store 204, such as the Apple Online Store. The online store 204 includes an interface for collecting an online customer's 206 order information and loan application details. In some embodiments, the online store 204 is configured for taking orders through a telesales interface 208.

In some embodiments of the present technology, the POS terminal 211 can include an interface for customers 213 to request a loan and submit loan application information.

In some embodiments of the present technology, customers 213 apply for financing via an online interface and receive a Loan ID prior to entering a physical store with a POS terminal. Accordingly, the POS terminal 211 can include an interface for customers 213 to enter their Loan ID. The POS terminal can also be operatively coupled, through the FSI engine 201, with the one or more software services 220 configured for providing backend inventory, order management, and payment collection services.

In some embodiments of the present technology, the sales outlets 205 include a business-to-business sales application 202 configured for interfacing with enterprise business customers 203, communicating with the FSI engine 201 and financing partners 290 via a business-to-business application tool 222.

In some embodiments of the present technology, the sales outlets 205 include a media/application distribution system 216 configured for allowing media consumers 217 to apply to finance media purchases with the financing partners 290 via the FSI engine 201.

The FSI engine 201 is configured for gathering loan application information from customers, sending loan application information to the financial partners 290, and receiving a Loan ID and loan approval information in return. Furthermore, the FSI engine is configured for communicating the order details to the software service 220 along with the Loan ID and configured for managing the order using the Loan ID. Accordingly, the FSI engine 201 serves as a central platform for managing the order using the Loan ID as a common identifier.

### User Experience

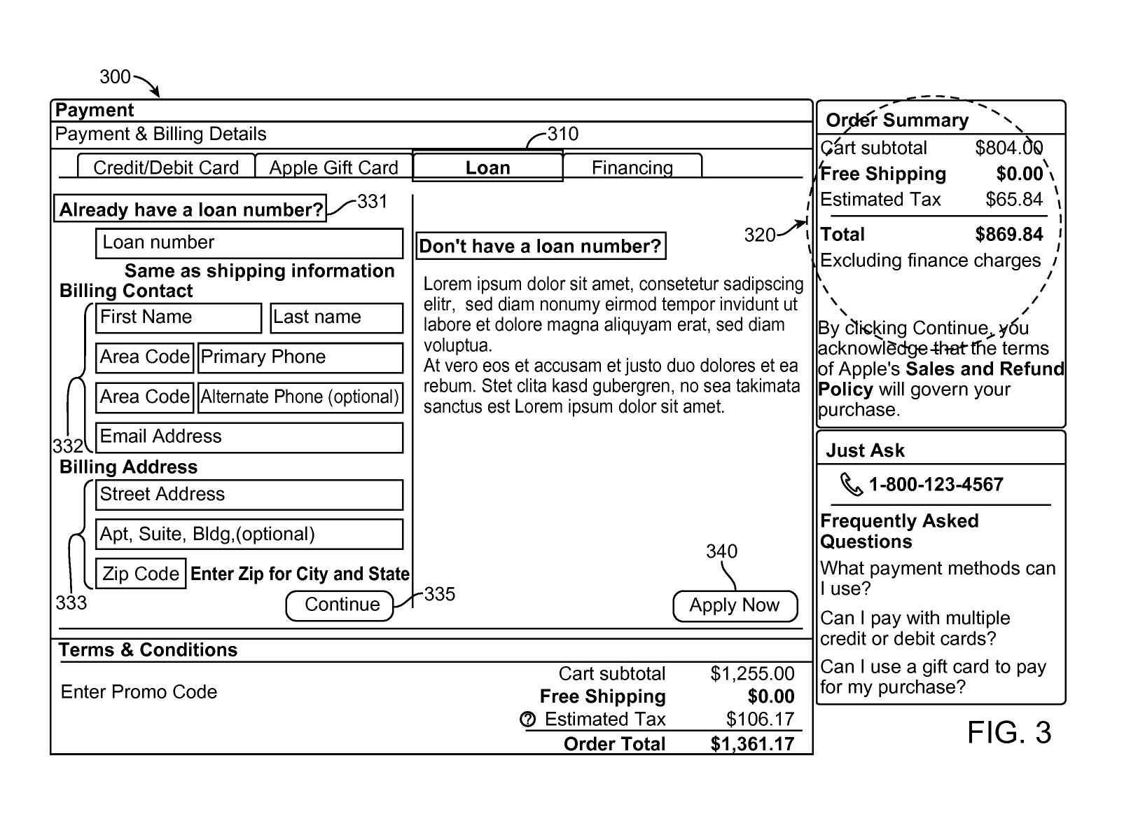

FIG. 3 illustrates an exemplary payment interface 300 provided to customers during checkout from an online retail store. As illustrated payment interface 300 includes a loan payment option which allows a consumer to checkout using a loan from a financing partner in consideration for the purchase. As illustrated in FIG. 3, a customer can click on a “Loan” tab 310 to access an option to finance a purchase. The “Loan” tab 310 includes fields 331, 332, and 333 for a customer to enter his Loan ID (if he has one already) 331, Contact Information 332, and Address 333.

The customer can indicate that he wishes to use financing to complete a transaction “upstream” from choosing items to purchase or “downstream” after shopping and choosing items to purchase. If the customer choses to use the financing upstream scenario, then the consumer can fill out a loan application using the FSI, which will assign the customer a Loan ID. Later, after selecting items to purchase the customer can be presented with purchase interface 300 and enter his Loan ID into the Loan ID field 331. After completing the required fields, the customer can click the “Continue” button to proceed to checkout using the Loan ID as consideration for the purchase.

If the customer choses to shop first and later indicate that he would like to apply for financing downstream, he can be presented with purchase interface 300, and click the “Apply Now” button 340 to apply for a loan with a financing partner through the FSI.

In some embodiments of the present technology, using a loan from a financing partner can take the place of using a credit card. A loan obtained through the FSI engine can resemble a personal line of credit and thus can be used as cash, thereby eliminating the need for incurring transaction costs such as authorization fees, interchange fees, settlement fees that are associated with credit card purchases. Likewise, the cost of setting up FSI engine compatibility can be much less than the setup cost for a similarly-featured online credit card checkout tool.

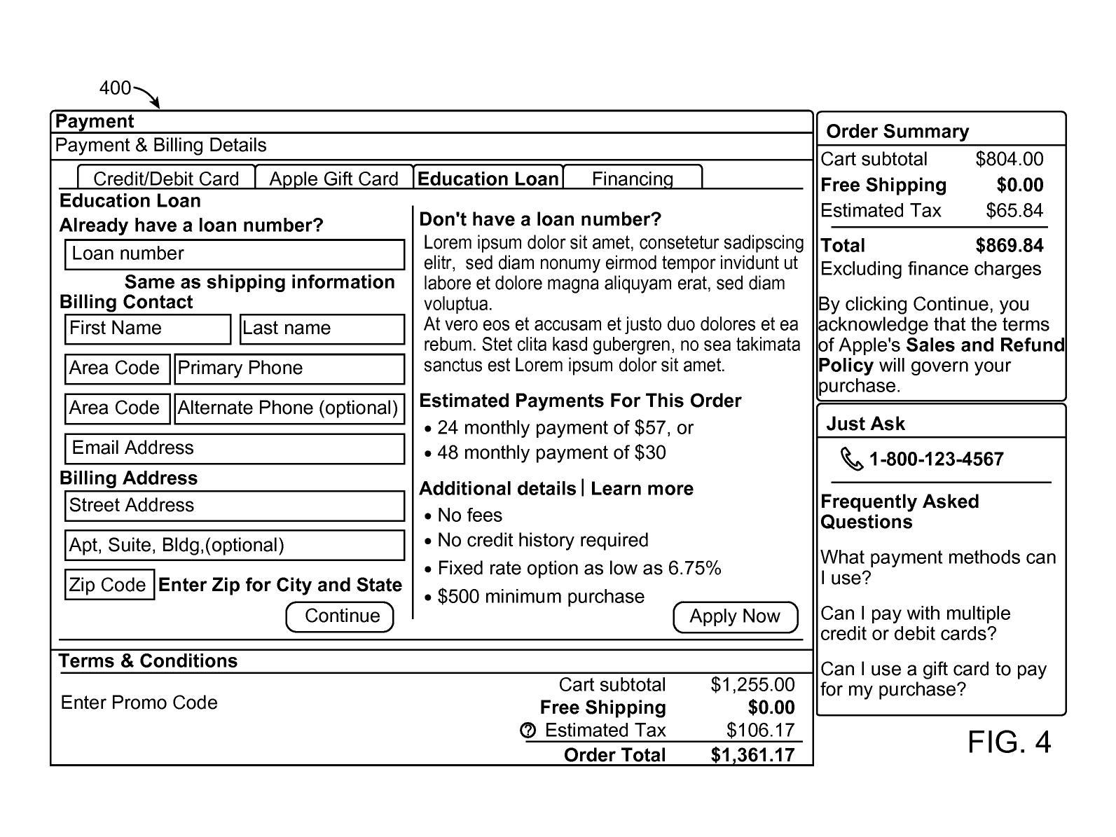

The FSI engine can be used to automate the financing process for a wide variety of financing scenarios such as personal loans, educational loans, leases, etc. For example, a banking partner can setup an educational loan program for students, or for students of a particular institution, to finance computer equipment needed for their education. FIG. 4 illustrates an exemplary interface 400 for customers to checkout of an online retail store using a Loan ID number relating to an educational loan according to some embodiments of the present technology. Like the personal loan example above, customers can chose to checkout using an educational loan either upstream or downstream of an order selection.

In some embodiments of the present technology, a customer applies for and receives a loan for a one-time transaction. In some other embodiments, a customer obtains a loan for a larger amount than needed for a single transaction (aka “umbrella” loan) and uses the loan to checkout items in a series of transactions that deducts the loan amount (aka against umbrella).

### Exemplary Methods

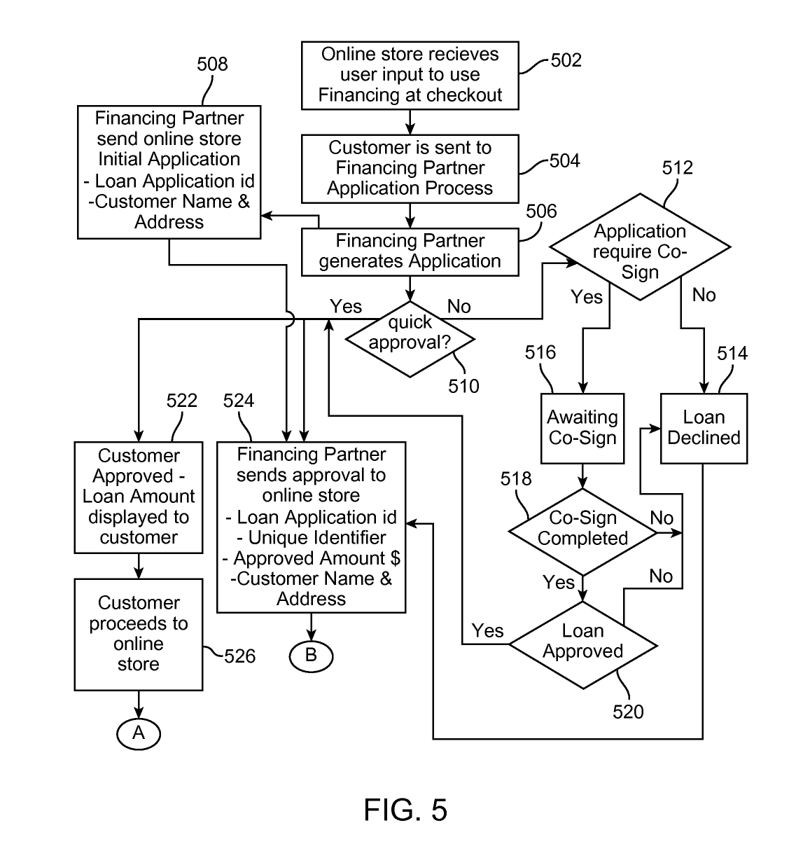

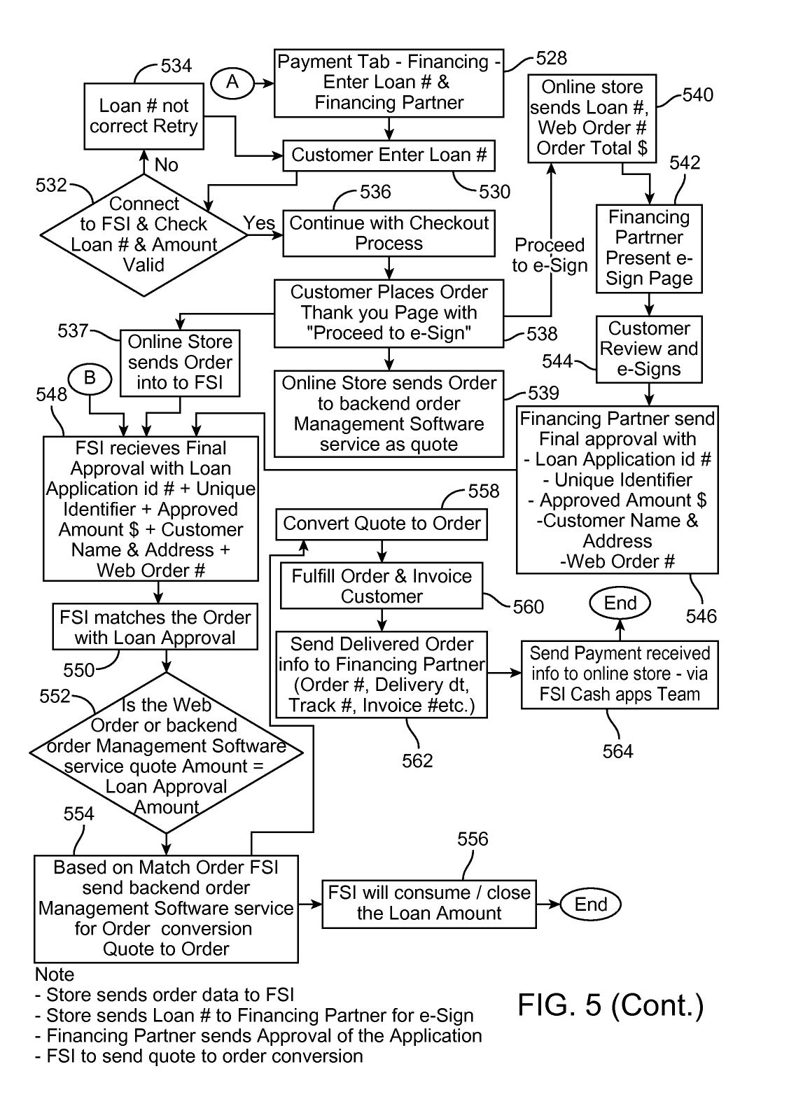

FIG. 5 illustrates an exemplary method 500 approving a customer for a loan upstream from selecting items to purchase and using a Loan ID to pay at checkout according to some embodiments of the present technology. The method 500 begins with an online store receiving 502 a user input to use financing to checkout “upstream” from making an order selection. Upon clicking the financing option, the customer is navigated 504 to an application interface for a financing partner. For example, in the case of a bank extending a loan to customer, the customer is directed to the bank's application process. In some embodiments, the financing partner's loan interface is presented with an interface provided by the FSI engine. Through the financing partner's loan application interface, the customer provides customer data and selects financing options and the financing partner generates 506 the loan application. Upon processing the application, the financing partner sends 508 the application information, including the Loan ID and customer information, such as name and address to the FSI engine. At this point the customer, the FSI engine, the financing partner, and the backend software system can all use the Loan ID as a common reference.

Next, the financing partner determines whether to approve a loan for the customer and for what amount of money. In some embodiments of the present technology, the method 500 involves a financing partner making a first determination 510 whether to allow “Quick Approval” depending on the customer's application information. A determination not to allow a quick approval can result in determining 512 whether the loan will require a co-signature from a co-applicant in order to be granted, or that the loan cannot be made. If the financing partner determines that the loan cannot be granted even with a co-signer, the loan is denied 514 and the financing partner notifies the FSI engine. If the financing partner determines that a co-signer is required, the process continues with awaiting a co-signature 516. If the co-signature is completed 518 to the financing partner's approval, the financing partner finally determines whether to approve the loan 520. If the loan is finally approved, the financing partner notifies the FSI engine. On the other hand, if the co-signature is not received or the loan is otherwise not approved, the loan is declined 514.

Once the financing partner makes a decision on a loan application, the FSI receives 524 Loan ID, the loan approval data, a unique identifier, an approved amount, and the customer's identification information, such as name and address from the financing partner.

Additionally, once the financing partner makes a decision on a loan application, a Customer-Approved Loan Amount (or a Zero amount in the case of an application being denied) is displayed 522 to the customer and the customer proceeds to shop 526 in the online store.

After the customer has selected items for purchase, a checkout interface provided by the online stores receives a selection of a pay with loan checkout option 528. After providing the pay with loan checkout interface, the user can provide 530 their Loan ID, which can be received by the checkout interface. Next, a determination 532 is made by FSI engine whether the customer-entered Loan ID matches a valid the Loan ID known to the FSI engine. If the entered ID does not match the Loan ID in the FSI engine, the customer is prompted 534 within the checkout interface to retry entering the Loan ID. However, if FSI engine determines that the Loan ID matches a valid Loan ID, the method 500 continues 536 with the checkout process.

Once the customer confirms the order and places the order, they are directed to a “Thank You” page and provided with a link to “Proceed to e-Sign” 538. Also, the online store sends 539 the orders, as a quote, to the backend order management software service and sends 537 the order to the FSI engine.

Upon the customer activating the “Proceed to e-Sign” link, the online store sends 540 the Loan ID, the order number, and the order price total to the financing partner. The financing partner generates an e-Sign page and presents 542 it to the customer. The customer reviews the e-Sign page and e-Signs 544. Next, the financing partner receives the e-Signed page and sends 546 final approvals to the FSI engine.

Next, the FSI receives 548 Loan ID, the order number, the final approvals, a unique identifier, the approved amount, and the customer's identification information, such as name and address from the financing partner and from the online store. The FSI engine performs a failsafe by matching 550 the order number received with the final approvals to the order number received from the online store. Also, a determination 552 is made to ensure that the order amount quoted (in step 539) matches the amount approved and e-Signed. Based on a match, the FSI engine sends an instruction to the backend order management software service to convert 554 the quote to an actual order. Next, the FSI closes 556 the loan.

The backend order management software service actually converts 558 the quote into an order. Next, the backend order management software service of the FSI fulfills the order, invoices the customer 560, and sends 562 the financing partner the order information. Finally, the financing partner sends payment to the online store 564. In some embodiments of the present technology, the payment is tendered via an automated clearinghouse or a private exchange system, such as Electronic Brokering Services (EBS).

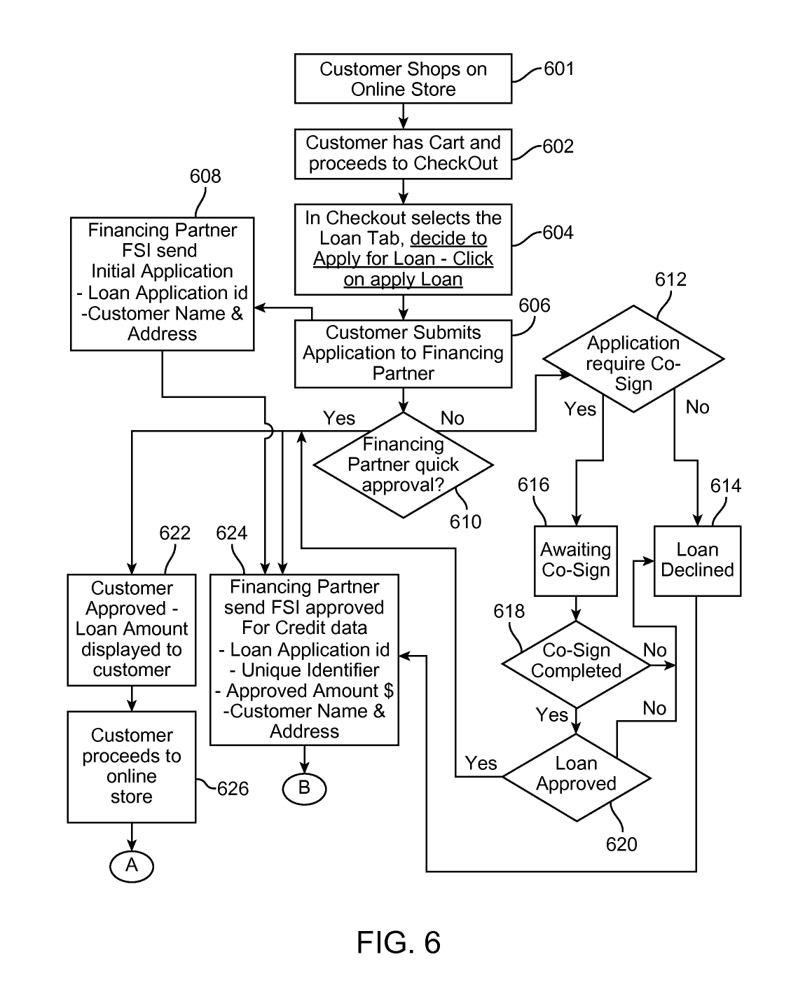

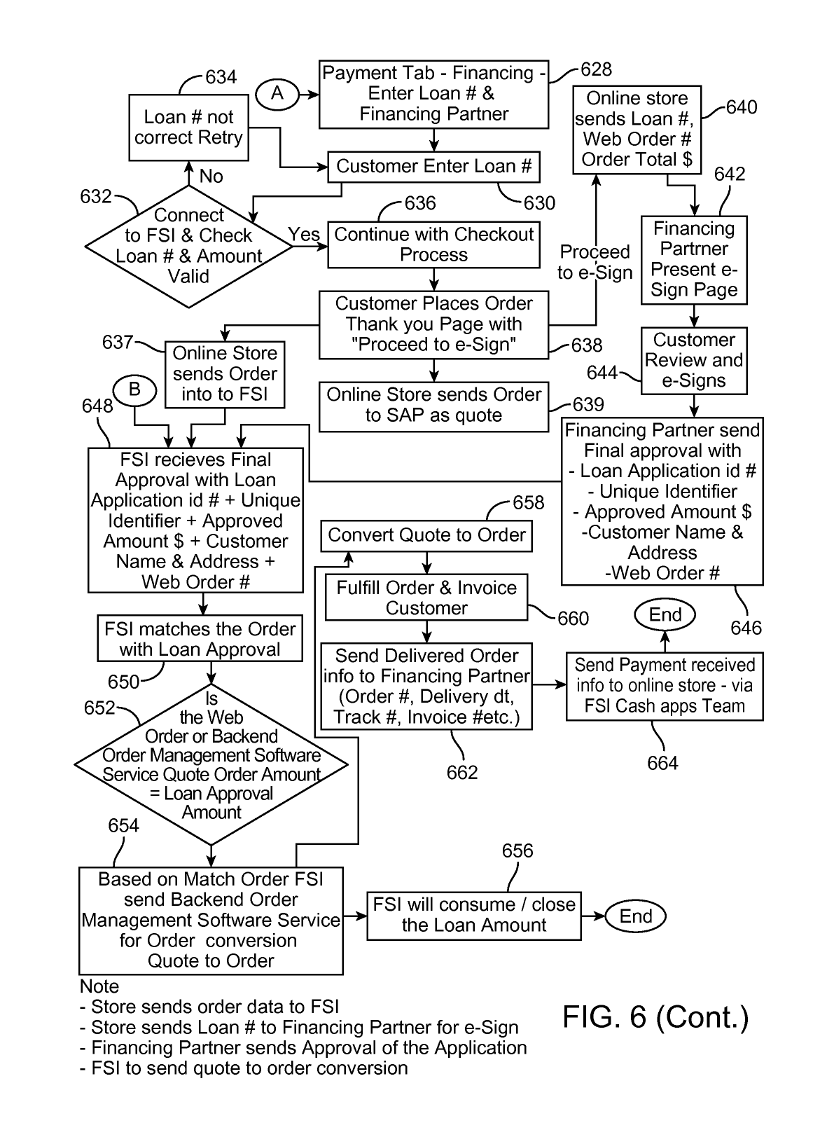

The exemplary method 500 illustrated in FIG. 5 pertains to a customer applying for a loan upstream from making an online purchase. FIG. 6 illustrates an exemplary method 600 of checking out a customer who first shops and later applies for a loan at checkout (i.e., downstream) according to some embodiments of the present technology.

As illustrated in FIG. 6, a customer shops 601 with a sales partner, fills an online-store-shopping cart with one or more items and proceeds 602 to checkout. Using an online store checkout interface, the customer selects a link to “Apply for a Loan” 604.

The financing partner's loan application interface receives the loan application submitted by the customer 606. Upon receiving the application, the financing partner sends 608 the FSI engine the application information, including the Loan ID and customer information, such as name and address. At this point the customer, the FSI engine, the financing partner, and the backend software system can all use the Loan ID as a common reference.

Next, the financing partner determines whether to approve a loan for the customer and for what amount of money. In some embodiments of the present technology, the method 600 involves a financing partner making a first determination 610 whether to allow “Quick Approval” depending on the customer's application information. A determination not to allow a quick approval can result in determining 612 whether or not to allow the loan application to proceed after receiving a co-signature from a co-applicant. If the financing partner determines that the loan is not approvable, even with a co-signature, the loan is denied 614 and the financing partner notifies the FSI engine. Otherwise, the method 600 continues with awaiting a co-signature 616. If the co-signature is completed 618 to the financing partner's approval, the financing partner finally determines whether to approve the loan 620. If the loan is finally approved, the financing partner notifies the FSI engine. On the other hand, if the co-signature is not received or the loan is otherwise not approved, the loan is declined 614.

Once the financing partner makes a decision on a loan application, the FSI receives 624 Loan ID, the loan approval data, a unique identifier, an approved amount, and the customer's identification information, such as name and address from the financing partner.

Additionally, once the financing partner makes a decision on a loan application, a Customer-Approved Loan Amount (or a Zero amount in the case of an application being denied) is displayed 622 to the customer within the online store 626. Now returned to the online store payment interface, the customer is navigated to an interface pertaining to 628 a loan checkout option. The customer enters 630 a Loan ID. Next, a determination 632 is made by checking the customer-entered Loan ID with a Loan ID known to the FSI. If the entered Loan ID does not match the Loan ID in the FSI engine, the customer is prompted 634 to retry entering the Loan ID. However, if a Loan ID matches the entered Loan ID, the method 600 continues 636 with the checkout process.

Once the customer confirms the order and places the order, they are directed to a “Thank You” page and provided with a link to “Proceed to e-Sign” 638. Also, the online store sends 639 the orders, as a quote, to the backend order management software service and sends 637 the order to the FSI engine.

Upon the customer activating the “Proceed to e-Sign” link, the online store sends 640 the Loan Id, the order number, and the order price total to the financing partner. The financing partner generates an e-Sign page and presents 642 it to the customer. The customer reviews the e-Sign page and e-Signs 644. Next, the financing partner receives the e-Signed page and sends 646 final approvals to the FSI engine.

Next, the FSI receives 648 Loan ID, the order number, the final approvals, a unique identifier, the approved amount, and the customer's identification information, such as name and address from the financing partner and from the online store. The FSI engine performs a failsafe by matching 650 the order number received with the final approvals to the order number received from the online store. Also, a determination 652 is made to ensure that the order amount quoted (in step 639) matches the amount approved and e-Signed. Based on a match, the FSI engine sends an instruction to the backend order management software service to convert 654 the quote to an actual order. Next, the FSI closes 656 the loan.

The backend order management software service actually converts 658 the quote into an order. Next, the backend order management software service fulfills the order and invoices the customer 660 and sends 662 the financing partner delivered order information. Finally, the financing partner sends payment to the online store 664.

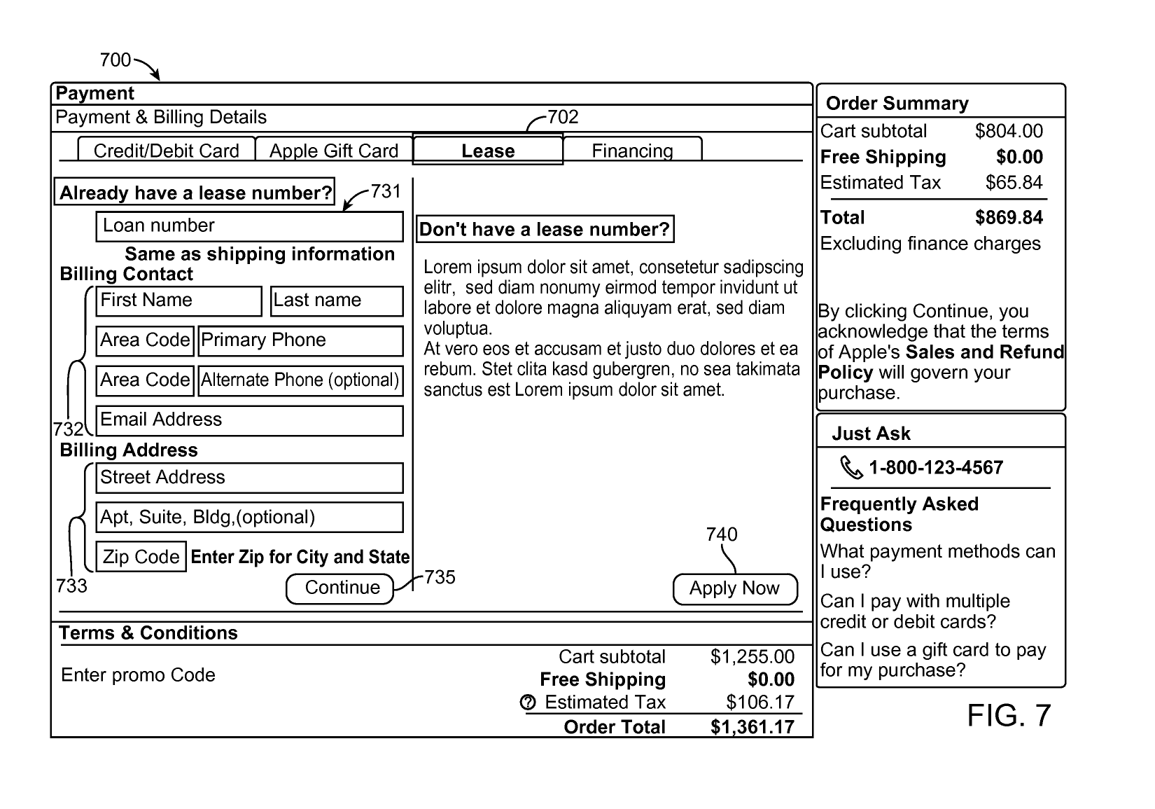

In addition to the financing partners providing loans and lines of credit to customers, some embodiments of the present technology involve the financing partners providing lease agreements for leasing items from the sales outlets. FIG. 7 illustrates an exemplary online interface 700 for a customer to apply to lease items from an online retailer via a lease agreement from a financing partner according to some embodiments of the present technology.

### Enterprise Business Customer Experience and Exemplary Methods

As illustrated in FIG. 7, a customer can click on a “Lease” tab 702 to access an option to lease items available from the online retailer. The “Lease” tab includes fields 731, 732, and 733 for a customer to enter his Lease ID 731, Contact Information 732, and Address 733.

The customer can indicate a desire to lease items “upstream” from choosing items to purchase or “downstream” after shopping and choosing items to lease. If the customer choses to use the financing upstream scenario, then the FSI will assign the customer a Lease ID (after a lease application has been completed) and the customer can enter his Lease ID into the Lease ID field 731. After filing the required fields, the customer can click the “Continue” button 735 to proceed to checkout using the Loan ID. If the customer choses to shop first and later indicate that he would like to apply for financing downstream, he can click the “Apply Now” button 740 to apply for a lease with a financing partner.

As explained above, some embodiments of the present technology involve individual customers making online sales, leases, etc. using financing received through a financing partner. Additionally, some embodiments of the present technology involve business-to-business sales using financing from third party financing partners.

Referring again to FIG. 2, the sales outlets 205 can include an online business-to-business retail application 202 for interacting with enterprise business customers 203. As shown in FIG. 2, the online business-to-business retail application 202 is operatively coupled with the FSI engine 201 via an application tool 222 configured to facilitate a process of business-to-business leases and loans for goods and services. The application tool 222 is also operatively coupled with a financing partner from the financing partners 290. Accordingly, the enterprise business customer 203 wanting to lease hardware or finance a sale from online business-to-business retail application 202 can transmit a request for financing with the financing partner via the FSI engine. Next, the FSI engine can receive a loan approval communication from financing partner and complete the transaction for the items secured by the approved loan through the FSI engine 201 and the application tool 203. Additionally, the FSI engine 201 is operatively coupled with a software service 220 configured for providing backend order management and payment collection services for the business-to-business transaction.

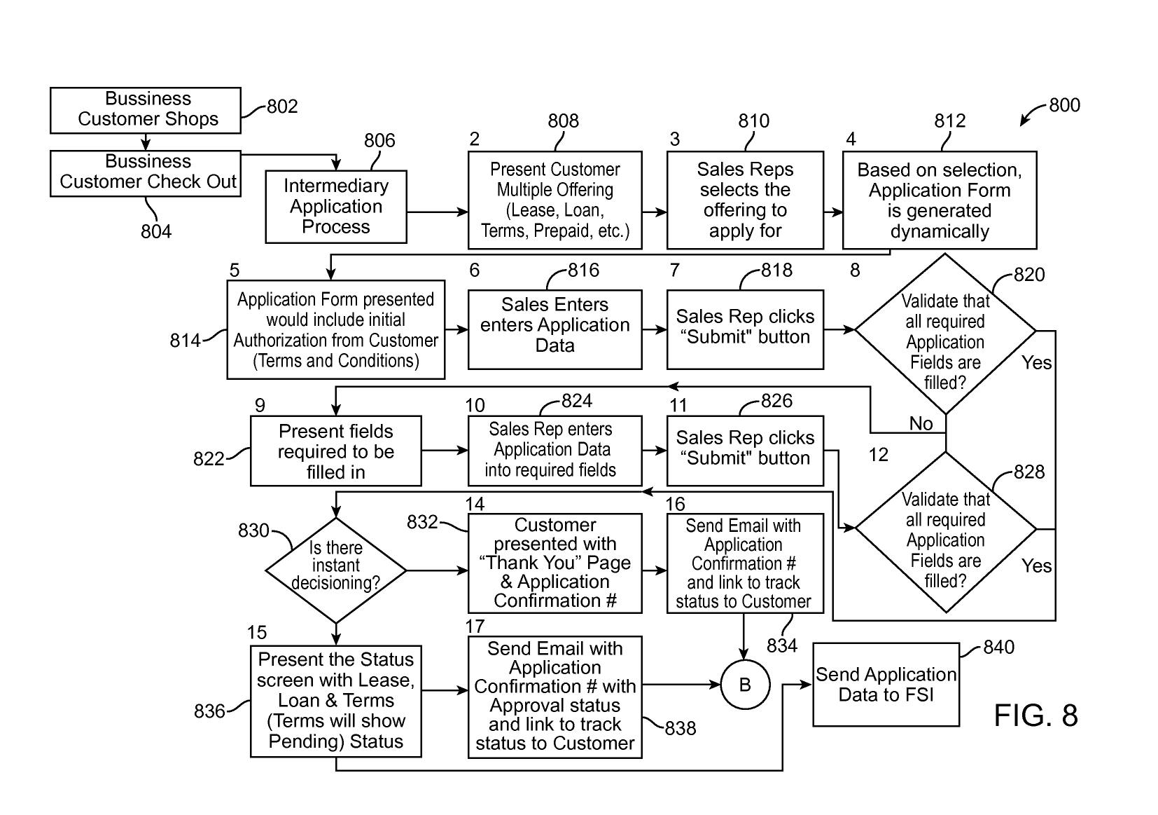

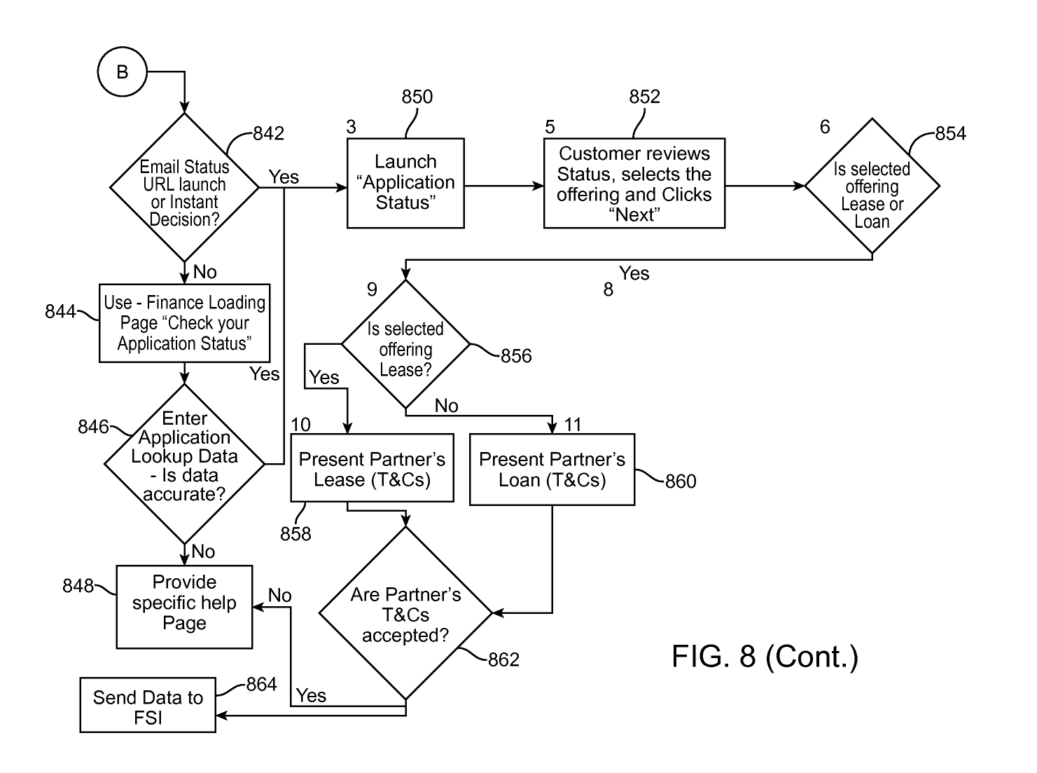

FIG. 8 illustrates an exemplary method 800 of taking orders from enterprise business customer, securing financing, and order fulfillment in an enterprise business financing scenario according to some embodiments of the present technology.

The method 800 begins with an enterprise business customer shopping 802 in an online business-to-business (“B2B”) market. Next, the enterprise business customer chooses to Checkout using a financing option 804. As explained above, some embodiments of the present technology involve an intermediary application tool for facilitating the financing application and ordering processes. Indeed, the method 800 involves initiating an intermediary process 806 that is used in many of the remaining steps. The enterprise business customer is presented 808 with multiple financing offerings from one or more of the financing partners.

In some embodiments of the present technology, the enterprise business customer navigates the online market alone, chooses items, and applies for financing. In some embodiments, the enterprise business customer is assisted by a sales representative of the market, e.g. an inside or outside sale representative. As shown in FIG. 8, a sales representative selects the financing options on behalf of the enterprise business customer 810. Based on the financing offering selected, an electronic application form is automatically, dynamically generated 812 by the intermediary application. In some embodiments of the present technology, the application form includes initial terms and conditions 814.

Next, in some embodiments, the sales representative enters 816 the customer's application data into the application form and submits 818 the form to the intermediary application. Next, the intermediary application validates 820 that all of the required fields are filled out. If not, the intermediary application presents 822 the required fields (e.g. by denoting them in red) and the sales representative fills 824 out the required fields and again submits 826 the application form. The intermediary application again validates 828 that all of the required fields are filled out.

Next, a determination 830 is made as to whether the application can be instantly approved. If so, the customer is presented 832 with a “Thank You” page having an Application Confirmation Number and an email is sent 834 to the customer with the same information and a link to follow the status of the financing sale. If an instant decision is not able to be made, the customer is presented 836 with a status screen, an email is sent 838 to the customer to track the status of the application, and the application information is sent 840 to the FSI engine.

Next, a determination 842 is made whether the enterprise business customer has accessed the financing purchase application status via an email link or was subject to an instant decision. If not, the customer is prompted 844 to check the application status and enter his credentials. After the enterprise business customer enters his application data, a determination 846 is made whether the information is correct. If not, a help page is provided 848. If so, or if the enterprise business customer used an email link and instant decision, the intermediary application launches 850 an application status interface for the enterprise business customer.

The enterprise business customer can review the application status, select a desired financing offering, and chose to move forward with the application 852. A determination 854 is made as to whether the enterprise business customer chose a lease or a loan. First, if it is determined 856 that the enterprise business customer chose a lease, the financing partner's lease terms and conditions are presented 858. Otherwise, if it is determined 856 that the enterprise business customer did not choose a lease, the financing partner's loan terms and conditions are presented 860. Next, a determination 862 is made as to whether the terms and conditions are acceptable to the enterprise business customer. If so, the FSI is notified and the FSI is sent the loan details 864. If not, the enterprise business customer is provided a specific help page 848.

Subsequently, a web order is fulfilled, the enterprise receives the order, the financing partner receives an update that the order was fulfilled (i.e. in a batch update), and the financing partner authorizes payment to the FSI operator.

In some embodiments of the present technology, the enterprise business customer receives a loan for an amount that exceeds a single order. In these embodiments, the Loan ID can be saved and used for future transactions.

### Point-of-Sale Experience and Exemplary Methods

Some of the scenarios above involve the sale of items via an online store. However, in some embodiments, a physical point-of-sale (POS) terminal is used in a brick-and-mortar store to gather order information and loan application details from a customer and to send the information to financing partners and the FSI engine. Referring again to FIG. 2, the FSI engine 201 can also be coupled with a POS terminal 211 which can be used to gather order information and loan application details from a customer and to send the information to financing partners and the FSI engine. In some embodiments of the present technology, the POS terminal comprises a mobile device running an application configured to gather order information and loan application details from a customer and to send the information to financing partners and the FSI engine.

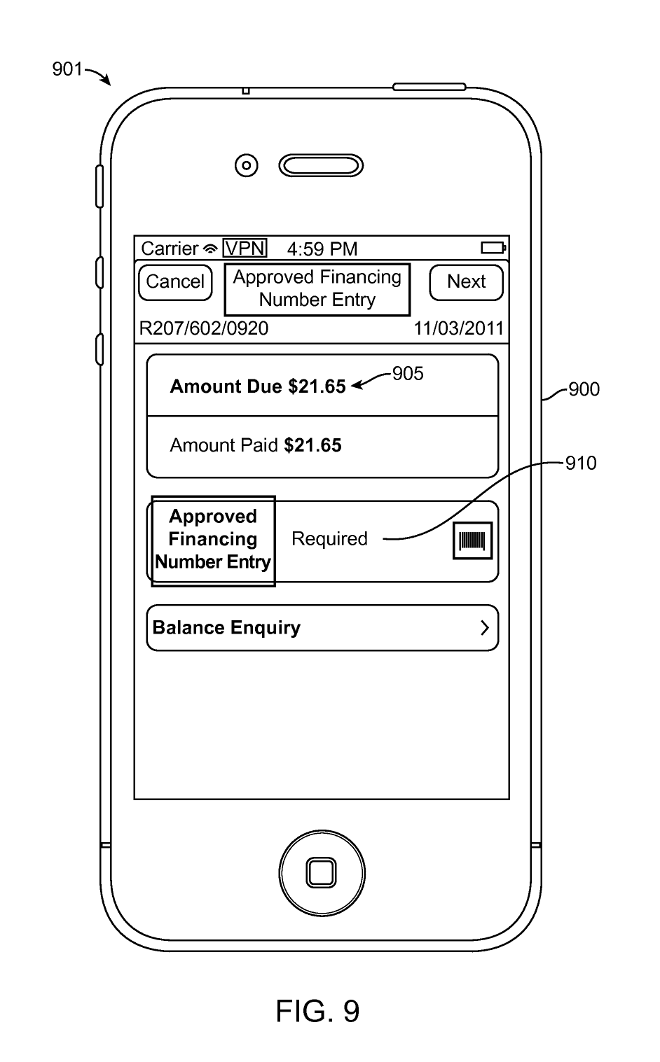

FIG. 9 illustrates an exemplary point-of-sale terminal interface 901 on a mobile device 900 according to some embodiments of the present technology. In some embodiments of the present technology, after shopping in a retail store, a customer can check out using the POS terminal interface 901 on the store's mobile device 900. In some other embodiments, the customer can check out using POS application downloaded to his own mobile device. Upon checkout, the interface 901 displays an amount of money 905 due and a field 910 for entering a Loan ID. In some embodiments of the present technology, the interface also includes tools for entering loan application information and for receiving approval along with a Loan ID. In some embodiments of the present technology, a customer uses an online interface to get pre-approved for a loan, receives a Loan ID (via the online interface, email, text message, QR code, etc.), and provides the Loan ID to a retail cashier to checkout.

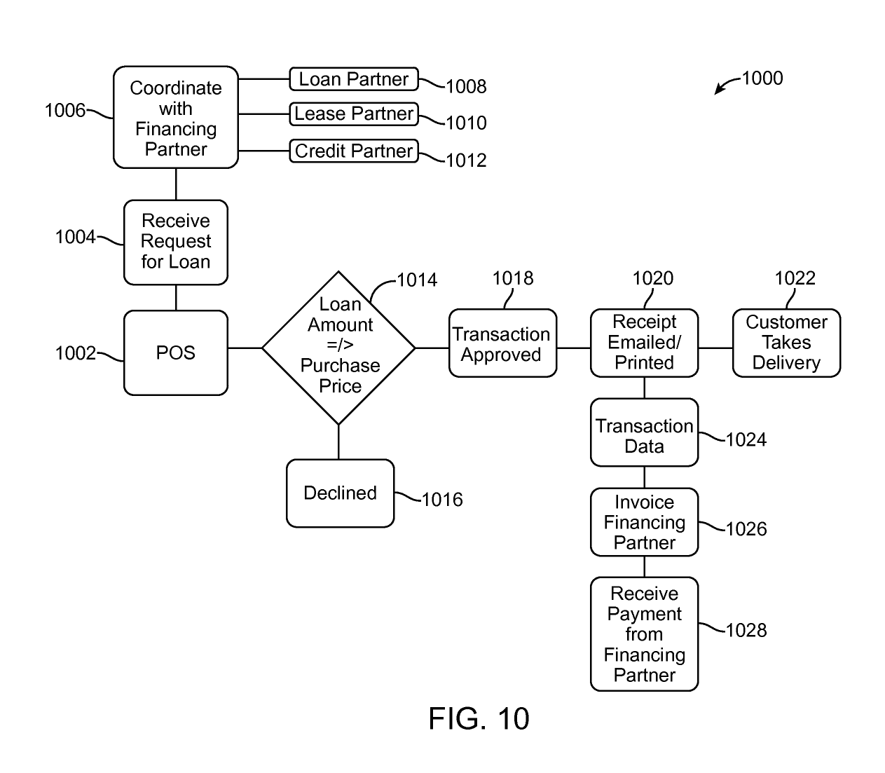

FIG. 10 illustrates an exemplary dataflow diagram illustrating a process 1000 of conducting a financing sale with a point-of-sale terminal according to some embodiments of the present technology. The financing sale begins with a customer checking out items at a POS terminal 1002. In some embodiments of the present technology, the POS terminal includes an interface for taking a customer's loan application data. Accordingly, the process 1000 also includes the POS terminal receiving a customer's request for a loan 1004. Upon receiving a request for a loan, the FSI engine coordinates with a financing partner for loan approval 1006. According to FIG. 8, a plurality of financing partners 1008, 1010, 1012 can be used to secure a loan, lease, or line of credit. Using the application submitted to the partners by the FSI engine, the financing partner approves a loan amount and transmits the loan amount, along with a Loan ID to the FSI engine and the POS terminal. Next, the authorized loan amount is compared 1014 to the checkout price using the POS terminal. If the loan amount is less than the POS receipt, the sale is declined 1016; however, if the loan amount is greater than or equal to the approved loan, the transaction is approved 1018, a receipt is printed or emailed to the customer 1020. If the items are in stock, the items are tendered to the customer 1022.

In some embodiments of the present technology, the retail store uses a software service configured for providing backend inventory, order management, and payment collection services. Accordingly, once a transaction is approved, the transaction data is sent to the software service 1024. Next, the software service invoices 1026 the financing partner and receives payment 1028 from the financing partner.

In the case of both POS transactions and online sales, customers sometimes experience technical issues or want to return or exchange purchased items. Accordingly, some embodiments of the present technology involve methods for dealing with returns, exchanges, etc. and for reconciling repayment or payment modification with financing partners.

### Order Management/Return and Exchanges

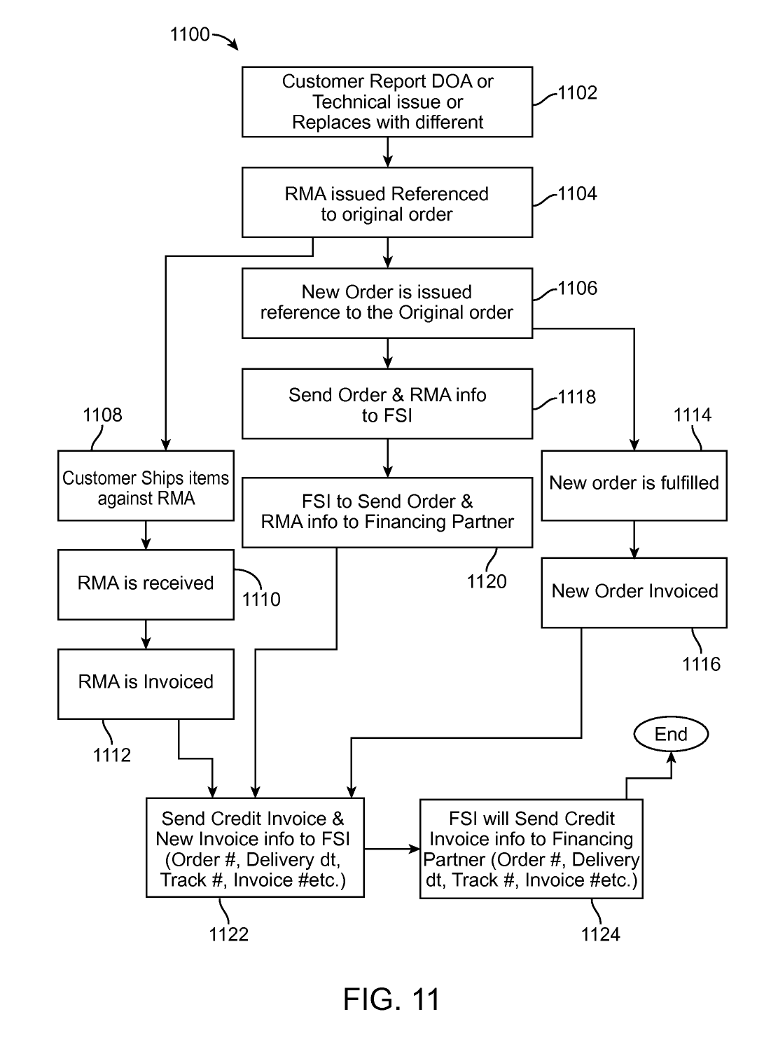

FIG. 11 illustrates an exemplary method 1100 of return merchandise authorization (RMA), new order fulfillment, and settlement with a financing partner according to some embodiments of the present technology. According to FIG. 11, a customer reports a technical problem, request a replacement item, or requests to return 1102. A return merchandise agreement (RMA) slip is issued by the software service 1104 which references the original order. Next, a new order is issued 1106 referencing the original order. In some embodiments of the present technology, reference to the original order is made to the original Loan ID.

When a RMA slip is issued 1104, the customer can ship 1108 the return items against the RMA. The retailer receives 1110 the return items along with the RMA information, the RMA information is recorded and invoiced 1112.

When a new order is issued 1106, the software service fulfills 1114 the new order and invoices 1116 the order. Also, when a new order is issued 1106, the order and RMA slip is sent to the FSI engine 1118 and the FSI engine sends 1120 the order and RMA slip to the financing partner.

When the RMA is invoiced 1112 after the return items are received, when the RMA is sent to the financing partner, and when the new order is invoiced, the FSI receives 1122 an updated credit invoice and sends 1124 the credit invoice to the financing partner.

### System Advantages

Using financing partners for providing loans and leases to customer can be advantageous. Setup costs are reduced for retail partners while transaction fees are eliminated Likewise, the present technology simplifies the process of obtaining financing on the customer side. Table 1 illustrates some of the system advantages.

TABLE 1

| | ADVANTAGE | RESULT |
|---|---|---|
| CUSTOMER | CONSISTENT LOOK AND COMPLETE VISIBILITY TO | INCREASED |
| EXPERIENCE | FINANCING APPLICATIONS (FINANCING PARTNERS | CUSTOMER |
| | CONFORM TO FSI OPERATOR'S STANDARDS) | SATISFACTION |
| | FULL SERVICE-LEVEL AGREEMENT VISIBILITY; OPEN ACCESS | DECREASED LEAD |
| | TO ALL PROCESSING STEPS | TIME |
| | SHORTER ORDER CYCLE TIME, LOWER COST PER ORDER | INCREASED |
| | | CUSTOMER |
| | | SATISFACTION |
| | ALLOWS ONLINE/INSTANT APPROVAL | INCREASED |
| | | CUSTOMER |
| | | SATISFACTION |
| SCALABILITY | ADDRESSES CURRENT SCALABILITY LIMITATION, PROVIDES | INCREASED |
| | MILLI-SECOND RESPONSE TIME | SCALABILITY |
| | SINGLE PLATFORM, STANDARDIZED FINANCING PARTNER | DECREASED LEAD |
| | ON-BOARDING PROCESS | TIME |
| | INEXPESNIVE ON-BOARDING PROCESS (REDUCTION FROM | DECREASED COST |
| | $1MILLION TO $300,000.00) WILL ALLOW GREATER | |
| | BREADTH OF LENDERS | |
| | FINANCING PARTNERS HAVE sku LEVEL INFORMATION TO | INCREASED |
| | SUPPORT “PRODUCT LEVEL PROMOTION” | CUSTOMER |
| | | SATISFACTION |
| RESOURCING | ELIMINATE MANUAL ORDER HANDLING PROCESS | DECREASED COST |
| | (AUTOMATICALLY CONVERT ORDER FROM QUOTE TO | PER ORDER |
| | ORDER, SAVES HEADCOUNT) | |
| | PROVIDE TELESALES, SSO/BACKOFFICE AND FINANCE | DECREASED COST |
| | FULL VIEW OF APPLICATION LIFE CYCLE | PER ORDER |
| | AUTOMATIC FINANCING PARTNER'S INTERFACE TO | DECREASED LEAD |
| | INCLUDE SHIPMENT AND INVOICE INFORMATION AND | TIME |
| | ENABLE QUICK PAYMENT TO FSI OPERATOR | |
| | UTILIZE PAYER MODEL TO ENABLE AUTOMATED | DECREASED LEAD |
| | CLEARINGHOUSE PROCESS OR ELECTRONIC BROKERING | TIME |
| | SERVICES AND ELIMNATE MANUAL CASH APPLICATION | |
| | PROCESS FOR GLOBAL FINANCE SHARED SERVICES | |

### Partner Integration

To reap the advantages described herein and the results summarized in Table 1, it must be easy to integrate the FSI engine with Financing Partner; therefore, some embodiments of the present technology involve using standard protocols and APIs to provide easy integration by financing partners and to be able to scale easily.

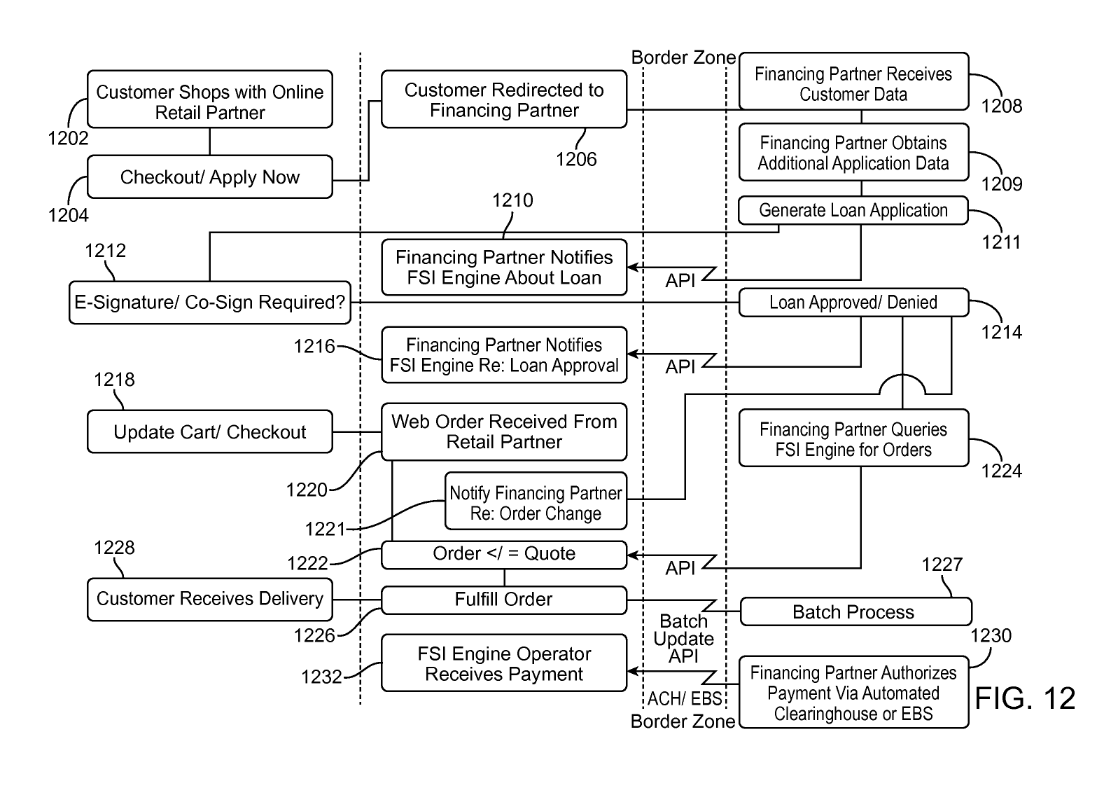

The Financial Service FSI engine can be designed to accept inputs, deliver requests, and accept request feedback from the sales and financing partners via uniform APIs and secure interfaces. FIG. 12 illustrates a high-level data flow diagram showing information exchange between the FSI engine and financing partners using standardized protocols and APIs according to some embodiments of the present technology.

For ease of explanation, FIG. 12 references a financing scenario in the realm of individual customer online sales; however, it will be readily apparent that the techniques illustrated in FIG. 12 and the advantages gained by the techniques are equally applicable to business-to-business financing scenarios, POS retail scenarios, media/application distribution scenarios, etc. FIG. 12 also shows actions taken on a client side, an FSI engine side, and a Financing Partner side; however, it will be readily apparent that these distinctions are exemplary only and that some actions can be performed on one or more of the client side, FSI engine side, or the Financing Partner side.

Additionally, FIG. 12 shows a “Borderzone” between the FSI engine side and the Financing Partner side. In some embodiments of the present technology, the Borderzone comprises one or more secure file transfer program (sFTP) servers, reverse proxy Switchboard servers, etc. In some embodiments, the financing partners access the FSI through a reverse proxy server. The reverse proxy server authenticates a certificate and generates (in the case of a first instance or one-time transaction) or looks up (in the case of an existing customer) an application password based on the application ID previously provided by the FSI engine operator. In return, the reverse proxy server sends a token back to the financing partner which can be used for subsequent web service requests. Additionally, batch updates (explained in greater detail below) sent between the FSI engine and the financing partners can be done via the sFTP server. In some embodiments the sFTP server will store the batch files for a period of time (e.g. seven days) before cleanup.

In some embodiments of the present technology, the Borderzone also includes one or more automated clearinghouse or a private exchange system, such as Electronic Brokering Services (EBS). According to these embodiments, payments across the Borderzone become more private and secure.

As illustrated in FIG. 12, a consumer shops 1202 in an online market. Next, a customer clicks 1204 on a link to apply for financing, and the click is received by the checkout interface. As explained above, the checkout interface can also include the basic fields of a loan application. Next, the FSI engine redirects 1206 the customer to the financing partner's web site. In some embodiments, the jump URL used to redirect the customer can be a base URL provided by the financing partner, plus web order number appended at the end. The financing partner receives 1208 customer data from the checkout interface, obtains 1209 any other required information through the financing partner's website, and generates 1111 a loan application. In some embodiments of the present technology, the loan application is based on a quote representing the expected amount of a purchase.

When a customer submits a loan and the financing partner receives the loan, the financing partner will notify 1210 the FSI operator that application has been submitted for this customer. The partner will provide a Credit Application ID and the web order number that was passed by the FSI operator in the jump URL. The partner consumes the FSI web-services to add the loan details and the customer details into FSI. In some embodiments, the notification to the FSI operator utilizes one or more security protocol in the “Borderzone” as discussed above.

In some embodiments, a standardized API is used for all partners to notify the FSI operator that an application has been submitted. Table 2 illustrates details of an exemplary API for partners to notify the FSI operator that an application has been submitted according to some embodiments of the present technology.

TABLE 2

| Web Service | |
|---|---|
| Name | FinancialService |
| Method | addCreditApplicationDS |
| Direction | Inbound (Partner -> FSI Operator) |
| Input Parameter | XML element LoanDetails. |
| Action | Customer submits the loan application at the partner |
| | site. The partner will notify FSI by consuming |
| | addCreditApplicationDS |
| Return | XML element ResponseStatus message. |
| Alternate flow | 1) Invalid loan applicationID if loan applicationID |
| in case of | is not provided or is null. |
| Exceptions | 2) Invalid customer details if customer details are |
| | not provided or is null. |

Table 3 illustrates exemplary Loan Details submitted in the notification to the FSI Operator by the API described in Table 1 according to some embodiments of the present technology.

TABLE 3

| Field Name | Data Type |
|---|---|
| Merchant ID | String |
| Web Order # | String |
| Loan Application ID # | String |
| First Name | String |
| Last Name | String |
| Address 1 | String |
| Address 2 | String |
| Address 3 | String |
| City Name | String |
| State/Province Code | String |
| Postal Code | String |
| Country Code | String |
| Phone Number | String |
| Status | String (New, Credit |
| | Approved, Approved |
| | (eSigned), Declined, |
| | Withdrawn |
| Customer Tax id # | String |
| Customer Federal Tax | String |
| id# | |
| Customer Vat id # | String |
| terms | int |

In some embodiments of the present technology, the Financing Partner requires a co-signor or an E-Signature from a customer before approving a loan application. Accordingly, the Financing Partner sends Co-Sign/E-Sign information to the customer. Upon receiving 1212 the required co-signature information or receiving an executed E-signed page, the Financing Partner approves or denies 1214 the loan application.

Once the Financing Partner approves or denies a loan application, the Financing Partner notifies 1216 the FSI operator that a loan has been approved or denied. In some embodiments, the notification to the FSI operator utilizes one or more security protocol in the “Borderzone” as discussed above.

In some embodiments, a standardized API is used to notify the FSI operator that an application has been approved or denied. Table 4 illustrates details of an exemplary API for partners to notify the FSI operator that an application has been approved according to some embodiments of the present technology.

TABLE 4

| Web Service | |
|---|---|
| Name | FinancialService |
| Method | updateCreditApplication |
| Direction | Inbound (Partner -> Apple) |
| Input Parameter | XML element LoanDetails. |
| Action | The partner will update application with loan details |
| | and update status whether loan was Approved, |
| | Declined, (e)signed or withdrawn. Based on the |
| | status and FSI will take action to notify internal |
| | components such as to update QT status |
| Return | Response will contain ResponseMessage, |
| | ResponseCode. |
| Alternate flow in | 1) Invalid App-id; if does not match our records |
| case of | for updating the loan information. |
| Exceptions | 2) InvalidCustomerDetails; if does not match with |
| | the exiting records of customer details to the |
| | corresponding app-id. |

Table 5 illustrates exemplary Loan Details submitted in the notification to the FSI Operator by the API described in Table 3 according to some embodiments of the present technology.

TABLE 5

| Field Name | Data Type |
|---|---|
| Merchant ID | String |
| Loan Application ID # | String |
| First Name | String |
| Last Name | String |
| Address 1 | String |
| Address 2 | String |
| Address 3 | String |
| City Name | String |
| State/Province Code | String |
| Postal Code | String |
| Country Code | String |
| Telephone Number | String |
| Status | String |
| Loan Number | String |
| Loan Amount | int |
| Currency Code | String |
| terms | int |

Depending on whether the customer originally applied for the loan upstream or downstream of checking out of an online retail store, the customer either updates his virtual shopping cart or checkouts 1218.

Additionally, after approving the loan, the Financing Partner queries 1224 the FSI engine for orders relating to the Loan ID. In some embodiments, the queries to the FSI operator utilizes one or more security protocol in the “Borderzone” as discussed above.

In some embodiments, a standardized API is used to query the FSI operator for the presence of orders. Table 6 illustrates details of an exemplary API for partners to query the FSI operator for the presence of orders according to some embodiments of the present technology.

TABLE 6

| | |
|---|---|
| Web Service | FinancialService |
| Name | |
| Method | getWebOrder |
| Direction | Inbound (Lender -> Apple) |
| Input Parameter | XML element OrderHeader |
| Action | The partner sends web order number in instance of |
| | OrderHeader class. Financial service will use this |
| | web order number to query the system and send |
| | back order details |
| Return | Response will contain Order details |
| Alternate flow | 1) Soap fault or exception will be thrown if web order |
| in case of | number is Null or it does not match our records |
| Exceptions | for given web orderNumber |

Table 7 illustrates exemplary Response Fields and Data Types expected from the FSI Operator in response to the API described in Table 6 according to some embodiments of the present technology.

TABLE 7

| Field Name | Data Type |
|---|---|
| Web Order Number | String |
| Loan Application ID | String |
| MerchantId | String |
| Currency code | String |
| Loan Amount | Int |
| Order total | Int |
| Tax | Int |
| BillToAddress | Customer |
| First Name | String |
| Last Name | String |
| Address 1 | String |
| Address 2 | String |
| Address 3 | String |
| City Name | String |
| State Code | String |
| Postal Code | String |
| Country Code | String |
| Telephone Number | String |

The FSI engine receives 1220 a customer's web order and determines 1222 if the price in the order is less than or equal to the price quoted in the loan application. In some embodiments of the present technology, the FSI operator notifies 1221 the Financing Partner of the change and the process reiterates the loan approval process.

Upon receiving an order that matches the loan amount or is otherwise deemed acceptable, the FSI operator fulfills 1226 the customer's order. In some embodiments, the FSI engine utilizes one or more software service for providing backend inventory, order management, and payment collection services. Next, the customer receives 1228 delivery of the ordered items.

Additionally, when order conversion is successful, the FSI operator (via the software service) sends back a notification to FSI indicating the order went through. In some embodiments of the present technology, the notification comprises a batch of updates to the Financing Partner. In some embodiments, these batch updates are sent using a standardized API call. In some embodiments, batch updates are also sent any time the FSI engine experiences a triggering event relating to changes to the quote or the order. Examples of triggering events include a quote being created, a quote being cancelled, an order being created, the occurrence of partial or complete shipping or billing, the occurrence of partial or complete cancellation (i.e. line item deleted or quantity changed), and an order being completed.

In some embodiments, the notification to the FSI operator utilizes one or more security protocol in the “Borderzone” as discussed above to send batch updates. For example, the FSI can use an EAI file adapter (sFTP) to send batch files to the partner and the batch files can stay at the sftp location for a specified duration.

Once an order is completed and the Financing Partner receives 1227 a batch update indicating the same, the Financing Partner can authorize 1230 payment to the FSI operator. In some embodiments of the present technology, the payment is tendered via an automated clearinghouse or a private exchange system, such as Electronic Brokering Services (EBS). Finally, the FSI engine operator receives 1232 payment.

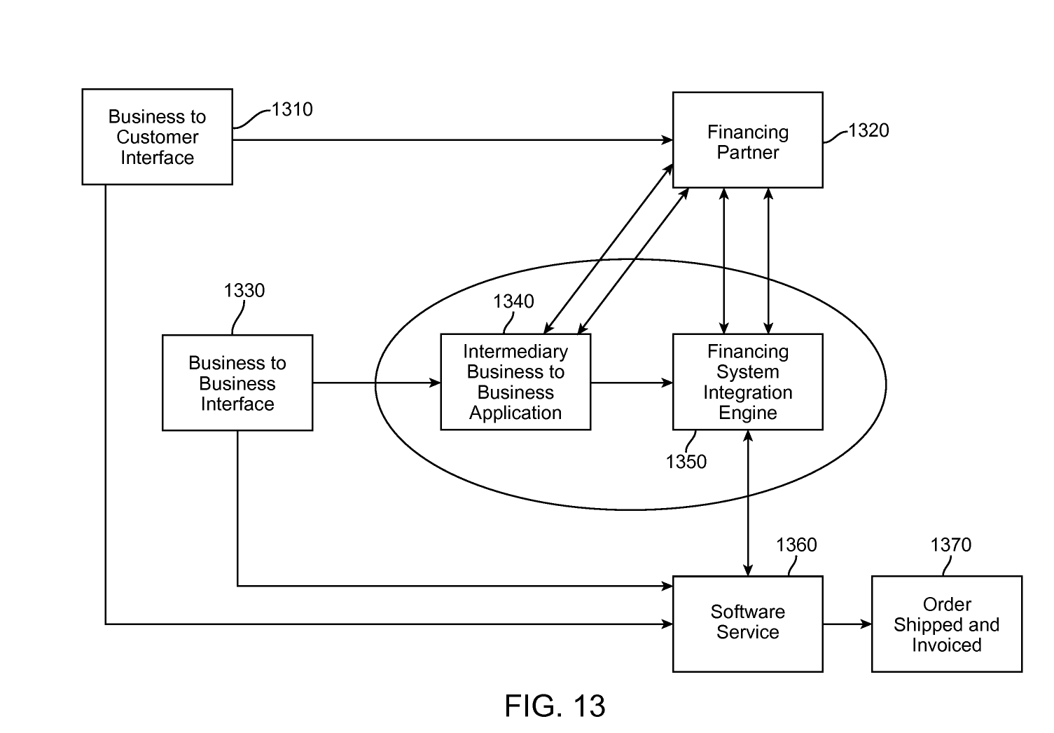

FIG. 13 illustrates a system diagram showing high-level interaction between the FSI engine, customers, and financing partners using standardized protocols according to some embodiments of the present technology. As shown in FIG. 13, a customer interfaces with a FSI engine 1350 via a business to customer interface 1310 and a software service 1360 and applies for a loan with a financing partner 1320. The financing party 1320 notifies the FSI engine 1350 about the loan using a standard API, e.g. the API discussed with reference to Tables 2-3 above. Upon receiving a memorialized E-Signature from the customer, the financing partner 1320 notifies the FSI engine 1350 regarding loan approval using a standard API, e.g. the API discussed above with reference to Tables 4-5 above. The customer places an order via the business to customer interface 1310 and the financing partner 1320 queries the FSI engine regarding the presence of orders using a standard API, e.g. the API discussed in reference to Tables 6-7 above. Next, the order is fulfilled using the software service 1360 and the order is shipped and invoiced 1370. In the case of a business to business interface 1330, a business customer works with the financing partners 1320 and the FSI engine 1350 through an intermediary business to business application tool 1340.

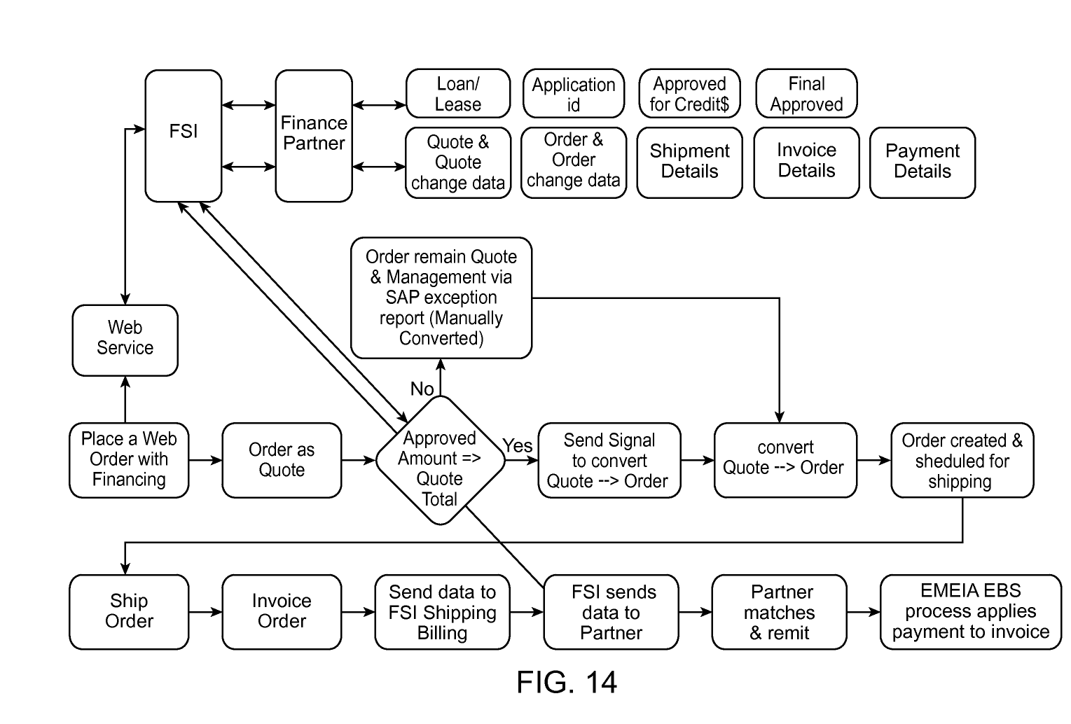

Financing institutions must comply with a number of regulations and rules. For example, in the United States, financing institutions must comply with Federally-mandated reporting laws. Accordingly, some embodiments of the present technology involve designing the FSI engine and API to allow U.S. financing institutions the ability for simple on-boarding and scaling. Likewise, foreign regulatory mandates can also be addressed to allow foreign financing institutions simple on-boarding and scalability. FIG. 14 illustrates an exemplary workflow 1400 for securing financing with a foreign financing institution and complying with Europe, Middle East, India, and Africa (EMEIA) regulations according to some embodiments of the present technology.

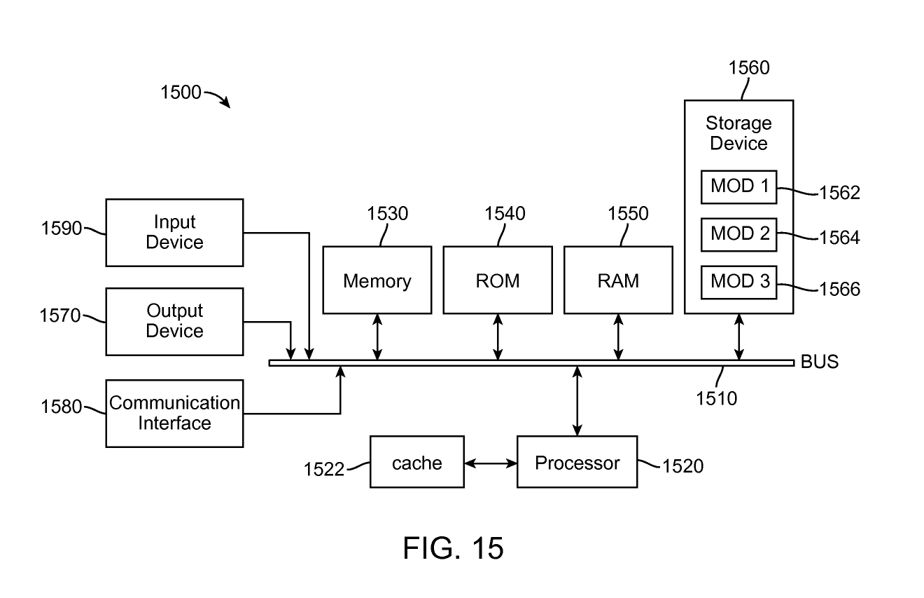

The systems and methods disclosed broadly herein are configured to be implemented on one or more computer systems. FIG. 15 illustrates an exemplary computer system according to some embodiments of the present technology. According to FIG. 15, the computer system 1599 includes a general-purpose computing device 1500, including a processing unit (CPU or processor) 1520 and a system bus 1510 that couples various system components including the system memory 1530 such as read only memory (ROM) 1540 and random access memory (RAM) 1550 to the processor 1520. The system 1500 can include a cache 1522 of high speed memory connected directly with, in close proximity to, or integrated as part of the processor 1520. The system 1500 copies data from the memory 1530 and/or the storage device 1560 to the cache 1522 for quick access by the processor 1520. In this way, the cache provides a performance boost that avoids processor 1520 delays while waiting for data. These and other modules can control or be configured to control the processor 1520 to perform various actions. Other system memory 1530 may be available for use as well. The memory 1530 can include multiple different types of memory with different performance characteristics. It can be appreciated that the disclosure may operate on a computing device 1500 with more than one processor 1520 or on a group or cluster of computing devices networked together to provide greater processing capability. The processor 1520 can include any general purpose processor and a hardware module or software module, such as module 1 1562, module 2 1564, and module 3 1566 stored in storage device 1560, configured to control the processor 1520 as well as a special-purpose processor where software instructions are incorporated into the actual processor design. The processor 1520 may essentially be a completely self-contained computing system, containing multiple cores or processors, a bus, memory controller, cache, etc. A multi-core processor may be symmetric or asymmetric.

The system bus 1510 may be any of several types of bus structures including a memory bus or memory controller, a peripheral bus, and a local bus using any of a variety of bus architectures. A basic input/output (BIOS) stored in ROM 1540 or the like, may provide the basic routine that helps to transfer information between elements within the computing device 1500, such as during start-up. The computing device 1500 further includes storage devices 1560 such as a hard disk drive, a magnetic disk drive, an optical disk drive, tape drive or the like. The storage device 1560 can include software modules 1562, 1564, 1566 for controlling the processor 1520. Other hardware or software modules are contemplated. The storage device 1560 is connected to the system bus 1510 by a drive interface. The drives and the associated computer readable storage media provide nonvolatile storage of computer readable instructions, data structures, program modules and other data for the computing device 1500. In one aspect, a hardware module that performs a particular function includes the software component stored in a non-transitory computer-readable medium in connection with the necessary hardware components, such as the processor 1520, bus 1510, display 1570, and so forth, to carry out the function. The basic components are known to those of skill in the art and appropriate variations are contemplated depending on the type of device, such as whether the device 1500 is a small, handheld computing device, a desktop computer, or a computer server.

Although the exemplary embodiment described herein employs the hard disk 1560, it should be appreciated by those skilled in the art that other types of computer readable media which can store data that are accessible by a computer, such as magnetic cassettes, flash memory cards, digital versatile disks, cartridges, random access memories (RAMs) 1550, read only memory (ROM) 1540, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 1500, an input device 1590 represents any number of input mechanisms, such as a microphone for speech, a touch-sensitive screen for gesture or graphical input, keyboard, mouse, motion input, speech and so forth. An output device 1570 can also be one or more of a number of output mechanisms known to those of skill in the art. In some instances, multimodal systems enable a user to provide multiple types of input to communicate with the computing device 100. The communications interface 1580 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 1520. The functions these blocks represent may be provided through the use of either shared or dedicated hardware, including, but not limited to, hardware capable of executing software and hardware, such as a processor 1520, that is purpose-built to operate as an equivalent to software executing on a general purpose processor. For example the functions of one or more processors presented in FIG. 15 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 1540 for storing software performing the operations discussed below, and random access memory (RAM) 1550 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 15 illustrates three modules Mod1 162, Mod2 164 and Mod3 166 which are modules configured to control the processor 1520. These modules may be stored on the storage device 1560 and loaded into RAM 1550 or memory 1530 at runtime or may be stored as would be known in the art in other computer-readable memory locations.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A system comprising:
a financing partner;
a store;
an integrated financing integration (FSI) engine configured to:
transmit a request for a financing product along with loan application information to the financing partner,
receive an approval communication from the financing partner,
complete a financial transaction with the store wherein the transaction exchanges a right in an item offered for sale by the store secured by the approved financing product, and
notify the financing partner of the transaction amount and item purchased with the approved financing product.

2. The system of claim 1, wherein the FSI engine is configured for receiving a loan number in a communication from the financing partner notifying the FSI engine that a customer has applied for a financing product.

3. The system of claim 2, wherein the FSI engine is configured to:
receive, from a customer, an order request using a loan number as payment;
receive a final approval communication from the financing partner; and
change the status of the financial transaction from a quote to an order, thereby completing the financial transaction.

4. The system of claim 2, wherein the FSI engine is configured to receive an approval update communication from the financing partner notifying the FSI engine that the loan associated with the loan number has been approved.

5. The system of claim 4, wherein the approval update communication includes one or more of the following loan status data items: new loan, credit approved, loan approved and eSigned, loan approved and co-signed, loan declined, loan withdrawn.

6. The system of claim 2, wherein the FSI engine is configured to send batch updates to the financing partner in a communication, wherein the batch updates include existing updated data field values for a plurality of data fields associated with the loan number.

7. The system of claim 1, wherein the FSI engine is further configured to receive payment from the financing partner for the completed financial transaction using an automated clearinghouse.

8. The system of claim 7, wherein the automated clearinghouse is further configured to receive from the financing partner a payment amount and the loan number, but not customer data, and wherein the automated clearinghouse processes payments using the payment amount and the loan number.

9. The system of claim 1, wherein the FSI engine is further configured for operating an online store backend management application.

10. The system of claim 9, wherein the backend management application is configured for:
managing orders for a plurality of customers;
coordinating shipping of orders and returns thereof;
storing and managing user accounts;
managing customer relationship management (CRM) data;
storing and managing an account for the third party bank;
receiving payment tender from the third party bank;
processing payments using approved loans;
managing product inventory; and
combinations thereof.

11. The system of claim 1, wherein the store comprises an interface for a customer to request a financing product, and wherein the request for a financing product is automatically transmitted to the financing partner upon a customer entering financing product application information and indicating that the customer would like to apply for a financing product.

12. The system of claim 1 wherein the store comprises an online store.

13. The system of claim 1 wherein the store comprises a point-of-sale (POS) retail terminal.

14. A method comprising:
receiving from a financial institution a loan approval communication including a loan number, a loan amount, and a loan application identifier;
receiving from a client device a purchase request for an item in a store and the loan number as payment for the item.

15. The method of claim 14, further comprising:
receiving a request for a loan from a customer along with loan application information; and
transmitting the request for a loan along with loan application information to the financial institution.

16. The method of claim 15, further comprising:
receiving, before receiving a loan approval communication, a loan application communication along with a loan number and order details; and
creating a quoted order based on the order details.

17. The method of claim 16, further comprising, upon receiving the loan approval communication, changing the quoted order to an approved order.

18. The method of claim 17, further comprising:
fulfilling an approved order by delivering the item to the customer;
notifying the financial institution that the order is fulfilled; and
receiving payment for the item from the financial institution.

19. The method of claim 15, further comprising sending batch updates to the financial institution, the batch updates relating to the quoted order, the approved order, the customer, and the loan application.

20. A method of conducting finance transactions on an integrated finance platform comprising:
collecting loan information, in connection with the transfer of a property right, from a customer;
providing the loan information to a financial institution for loan approval;
receiving from the financial institution, a loan approval, an application identifier, an approved loan amount, and a customer identification;
identifying the customer using the customer identification;
approving the transfer of the property right to the customer upon receiving the loan approval;
fulfilling the transfer of the property right; and
receiving payment from the financial institution upon fulfillment of the transfer of the property right to the customer.

21. The method of claim 20, further comprising receiving payment from the financial institution for the financial transaction using an automated clearinghouse.

22. The method of claim 21, further comprising receiving an anonymized payment from the automated clearinghouse, the anonymized payment comprising a payment amount and the loan number, but not customer data, such that the clearinghouse is not exposed to customer data.

23. A system comprising:
a financing institution;
a business-to-business (B2B) sales partner;
an integration platform comprising an integrated financing integration (FSI) engine and an intermediary application tool, wherein the intermediary application tool is configured to:
present the B2B sales partner with financing products;
obtain the B2B sales partner's financing product selections;
generate a financing application form for the B2B sales partner;
transmit a request for financing along with the application form to the financing institution;
receive an approval communication from the financing institution along with financing terms;
transmit the approval communication and financing terms to the B2B sales partner; and
receive the B2B sales partner's approval of the financing terms; and
wherein the FSI engine is configured to:
complete a financial transaction with the sales partner wherein the transaction exchanges a right in an item offered for sale by the sales partner secured by an approved financing product, and
notify the financing institution of the transaction amount and item purchased with the approved financing.

24. The system of claim 23, wherein the FSI engine is configured for sending batch updates to the financing partner in a communication, wherein the batch updates includes existing updated data field values for a plurality of data fields associated with a loan number.

25. The system of claim 23, wherein the FSI engine is further configured for receiving payment from the financing partner for the financial transaction using an automated clearinghouse.

26. The system of claim 23, wherein the financing partner sends the automated clearinghouse a payment amount and the loan number, but not customer data, and wherein the automated clearinghouse processes payments using the payment amount and the loan number.

27. The system of claim 23, wherein the FSI engine is further configured for operating a backend management application for the sales partner.

28. The system of claim 23, wherein the backend management application is configured for:
managing orders for a plurality of customers;
coordinating shipping of orders and returns thereof;
storing and managing user accounts;
managing customer relationship management (CRM) data;
storing and managing an account for the third party bank;
receiving payment tender from the third party bank;
processing payments using approved financing products;
managing product inventory; and
combinations thereof.

29. A computer-readable medium configured for performing the method of:
receiving from a financial institution a loan approval communication including a loan number, a loan amount, and a loan application identifier;
receiving from a client device a purchase request for an item in an online store and the loan number as payment for the item.

30. The computer-readable medium of claim 29, further configured for:
receiving a request for a loan from a customer along with loan application information; and
transmitting the request for a loan along with loan application information to the financial institution.

31. The computer-readable medium of claim 30, further configured for:
receiving, before receiving a loan approval communication, a loan application communication along with a loan number and order details; and
creating a quoted order based on the order details.

32. The computer-readable medium of claim 31, further configured for, upon receiving the loan approval communication, changing the quoted order to an approved order.

33. The computer-readable medium of claim 32, further configured for:
fulfilling an approved order by delivering the item to the customer;
notifying the financial institution that the order is fulfilled; and
receiving payment for the item from the financial institution.

34. The computer-readable medium of claim 29, further configured for sending batch updates to the financial institution, the batch updates relating to the quoted order, the approved order, the customer, and the loan application.
